(19) United States
(12) Patent Application Publication
(10) Pub. No.: US 2001/0053967 A1
(43) Pub. Date: Dec. 20, 2001

(54) Virtual summary jury trial and dispute resolution method and systems

(76) Inventors: Robert Gordon, Addison, TX (US); Leon Ashley Peek, Denton, TX (US)

Correspondence Address: James J. Murphy, Winstead Sechrest & Minick, 5400 Renaisannce Tower, 1201 Elm Street, Dallas, TX, 75270, US

(21) Appl. No.: 09/772,443

(22) Filed: Jan. 29, 2001

Related U.S. Application Data
(60) Provisional application No. 60/178,435, filed on Jan. 27, 2000.

(51) Int. Cl. G06F 9/45

(52) U.S. Cl. 703/22

(57) ABSTRACT

The present invention relates in general to the field of jury science conducted over a data processing network and in particular to using the Internet to apply a multi-discipline methodology and system to understand legal issues and the judicial process, consideration of those issues, to the understanding of how and why jurors and judges make decisions, and to understanding how, by including the understanding of the impact of this process, justice may be achieved. By applying jury science to the Internet for the first time, this methodology may be applied in a cost affective manner, free from logistical constraints.

### CROSS REFERENCE TO RELATED PATENTS

This application is related to the provisional application for patent entitled “Virtual Jury Methods and Systems” filed Jan. 27, 2000 by the inventors Gordon and Peek, granted U.S. Ser. No. 60/178, 435, currently pending.

### TECHNICAL FIELD

The present invention relates in general to the field of jury science conducted over a data processing network and in particular to using the Internet to apply a multi-discipline methodology and system to understand legal issues and the judicial process, consideration of those issues, to the understanding of how and why jurors and judges make decisions, and to understanding how, by including the understanding of the impact of this process, justice may be achieved. By applying jury science to the Internet for the first time, this methodology may be applied in a cost affective manner, free from logistical constraints.

### BACKGROUND INFORMATION

Solving disputes between adverse parties can fall within the province of the legal system. Many times disputes can only be resolved by the filing of a lawsuit. When this occurs, one party alleging certain causes of action against the other party files the lawsuit. After the formalization of the dispute through the filing of the lawsuit and its incorporation into the judicial process, the case might take a variety of paths, for example, the dispute might be resolved through a trial, through arbitration, or through mediation.

In between the period of the filing of the lawsuit and the final resolution of the claims, each party's respective counsel works to achieve the best result for their clients. This involves “working-up” the case in order to understand better the case's weakness and strengths from the client's side and the opposing side. The work-up process may include discovery requests, legal research and motions to the court in an attempt to gain as much information about the case as possible.

During the work-up period, counsel is continuously assessing the case's strengths and weakness from their client's point of view, and comparing this to the opposing side's similar strengths and weakness as new information about the case arises. This is a critical part of the attorney's case management, because it allows counsel to accurately quantify for his client the case's potential costs in terms of liability, actual attorney's fees of the case and trial expenses in both transactional and substantive areas. Such information may be important to the client in determining whether to proceed with the case to trial or to settle the case.

Consequently, accurate information about the case is a key element to the attorney's assessment of the case. However, counsel is often hindered in their analysis of the quantifiable liabilities of their client's case because of the difficulty in accurately predicting the view point of a potential triers of fact, jurors, and how they might weigh and evaluate the client's arguments when faced with the opposing party's arguments. This type of accurate behavioral analysis is usually outside counsel's area of expertise. Therefore, in the area of jury science, counsel's predictions can be wildly inaccurate with the result being to unknowingly place the client into a situation where the client's actual exposure is in excess to counsel's predictive assessment. This often leads to a “surprise” result for the client at trial and extreme tension between counsel and his client at best, and subsequent legal action against counsel by his former client at worst.

Additionally, counsel may be presented with the option of resolving the case through alternative dispute resolution proceeding or settlement negotiations. During this phase of the case, counsel may operate without a sound foundational understanding of the settlement value of his client's case if he fails to accurately predict a potential trier of fact's responses to his client's case. This can result in counsel having no sound foundational understanding of the “worth” of his client's case, and thus no framework for negotiating a settlement. Counsel is left to guess at the settlement value of the case and has not provided a basis by which they can guide their client through the settlement proceedings. In other words, because of counsel's lack of confidence or understanding in the errors in the accuracy of his own assessment of the case's strengths, weaknesses, and value, settlement negotiations are hampered because of potential unrealistic and unfounded expectations held by the clients. These unrealistic expectations are often based on counsel's honest but inaccurate assessment of the client's exposure or the client's emotional connection to the case. Without realistic expectations, often cases that should and can settle fail to settle.

In the recent past, legal and behavior scientists began to develop a methodology to assist counsel in accurately assessing the potential exposure of their clients' position in lawsuits. Referred to as “jury science” by those familiar with the art, the format of this methodology applies a multi-discipline behavior science approach to aid in understanding the legal issues involved. By using behavioral science within the confines of justice system's procedures to understand the decisions that at which judges and juries arrive, the jury scientist or researcher can understand how and why the triers of fact arrive at the conclusions they do, and can better quantify the impact that client's position may have on the conclusions that are reached. By applying jury science to the client's case during the work-up stage the attorney can arrive at a more accurate, predictive result based on reaction of triers of fact. The attorney can then better advise the client of his potential exposure, or settlement value of the case allowing the client to make a more informed decision regarding how to proceed with the case.

Previously, in order for the jury scientist to accurately apply the abovedescribed methodology, the jury scientist would conduct a mock trial of the case under controlled conditions. In order to gain the most accurate predictive result, the mock trials would be conducted under conditions that closely represented how the actual trial might occur.

Jury scientists have learned that as the mock trial approached a true representation of the actual trial, error in the predictive result dropped. Thus, the jury scientist worked to ensure that the actual witnesses, deposition exhibits, trial exhibits, client and attorneys were present for the mock trial. Additionally, the jury scientist worked to ensure that the mock judge for a bench trial, or mock jury for a jury trial, closely represented in behavioral terms what would be expected from the actual trier of fact in the chosen forum.

Because of the logistics involved in gathering all the exhibits and witnesses together and presenting them to a mock trier of fact, it was often necessary to conduct the mock trial over a weekend to ensure that all participants necessary could attend. Additionally, the location of the mock trial needed to be near the actual forum where the dispute was located to ensure an accurate representative of the triers of fact.

One of the most important aspects in ensuring the accuracy of the mock trial, is choosing an accurate representation of the trier of fact that is likely to be seated during the actual trial. Usually the trier of fact is a jury. Jury scientists have utilized various techniques to limit the errors in choosing a mock jury. The most common is to select a large mock jury from the local forum where the case would be tried. Jury scientists use driver's license list or voters registration lists to get a representative sampling of the potential jury. The choice of lists depends upon that which corresponds more closely to the methodology of the forum's jury selection rules.

After the jury pool is selected, the jury scientist then attempts to “pick” the correct representative sampling of the potential “jurors” from the mock jury pool. The jury scientist accomplishes this by having the potential mock jurors complete questionnaires and making the mock jury selection using the information provided by the responses. Typically, researchers will try to gain as large a representative sampling as possible. This allows the scientist to observe a larger group of people with differing behavioral patterns and thus minimize error.

After the jury scientist “picks” the mock jurors, the mock trial session begins. During this trial session, the client will present his case using the necessary witnesses, exhibits, video displays, or other trial techniques to present his client's case. Many times, a member of counsel's team will also play the opposing side advocating against his client in order to present both sides of the story to mock jurors.

During the presentations, often the jury scientist will present the mock jurors with various questions to answer concerning the trial exhibits, the witnesses or the various other trial techniques that the client used. In this manner, the jury scientist is able to gain a better understanding of the effectiveness of the various trial techniques that counsel is using.

Upon conclusion of the mock trial, the mock jury is sent into a deliberation room whereby they deliberate the questions presented for them to decide. Usually the mock jury room will have a method for the researchers and lawyers to view the mock jury during deliberations. A typical method is to provide a one-way mirror so that the researchers and client may view the deliberations while in progress. Another method used is to video tape the deliberations and provide a closed circuit patch to the researchers and client during deliberations.

By viewing the mock jurors during deliberations, the jury scientist is able to view the various dynamics involved during deliberations. This provides the researcher with a better understanding of how the trial techniques swayed various decisions amongst the jurors. Often during the deliberations, the researchers might enter the deliberation room and present a question to the jurors in order to have them focus on a particular issue or to speed up the process if necessary. Again, during the deliberations, the jury scientist might pose certain written questions for the mock jurors to answer in order to gain a better understanding of how the case was perceived by the jurors.

Upon conclusion of the mock trial session, the jury scientist will compile the results and formulate a conclusion for the client. Often, this compilation will include the video tape research, if any, of the jury deliberation, the questionnaires as answered by the jurors, and a detailed behavioral analysis of the various trial techniques that were used and their affect on the jurors.

One of the most important aspects of the mock trial session is to be able to have the mock trial jury conduct deliberations as a group. This is to more accurately simulate the conditions of an actual jury, and to observe the jurors as various arguments are deliberated amongst the group, allowing the researchers to observe how different behavioral characteristics amongst the jurors are swayed during deliberations. Therefore, previously, it was imperative that the jurors be in one central location, physically present, in order to allow the deliberations to occur amongst the jurors.

One problem in the past has been that when the researcher wanted to pose a question to the jurors as a group, or talk to specific individual jurors, the researcher needed to interrupt the deliberation session. Thus, all jurors were apprized then the researcher posed specific questions to specific jurors. This limited the researcher's ability to “plant a seed” and observe how the group as a whole reacted, or to question a juror privately outside of the full view of the jury in order to gain a better understanding of how that specific juror felt during the deliberation. This limited the researcher's ability to test various theories during the mock trial.

Another potential problem in the past has been that because of jurors' work schedules, most mock juries were required to take place during the weekend. This presented two problems. First, it required that the clients prepare and present their case within the confines of the workers' schedules. Secondly, many times researchers might not be able to gain as complete a jury pool as desired with the variance of behavioral patterns necessary to accurately predict the effect of the client's case during a mock jury. This might occur when a number of jurors may not be available due to their own scheduling conflicts.

Another problem has been that advanced planning has been necessary in order to send out the required requests to potential mock jurors stating the time, date and place where their services would be needed, and to ensure that the mock jurors were adequately informed. Thus, in the past if a client desired to have a mock jury performed quickly, for example, within a day's notice, the trial researcher often was unable to accommodate the client's request, and if able to accommodate the client, the expense often was prohibitive.

Because of the past constraints, the need for an accurate representation of the mock trial necessitated increased costs for conducting the mock trial. These costs included the preparation and shipping of any exhibit, witness transportation, lodging fees, hourly charges especially for expert witness, attorneys' time and expenses, and mock juror's time and efforts. Additionally, often the mock courtroom would need to be reserved and arrangements made for dining arrangements if the mock trials were of substantial length. Finally, because a mock jury must be gathered together to see, hear and discuss the presentation, previously the mock trial needed to be conducted at a central location in the chosen forum. Because of these fixed costs, mock trials conducted under the expertise of trained jury scientists often were cost prohibitive for all but the most expensive cases, for example those where the client's liability exposure can be measured in the millions if not hundreds of millions of dollars.

The logistical arrangements involved in conducting a mock trial often reduced the flexibility needed to conduct it and thus, reduce the accuracy of the predictive result. For example, often all of the actual witnesses cannot attend the mock trial on the chosen date. Many times, a suitable location cannot be procured due to a shortage of locations in the forum where the case was to be tried. Or, often a suitable number of mock jurors cannot arrange their schedules in order to attend the entire session. These limitations often caused the researcher to cancel the mock trial, or limit his ability to conduct appropriate research.

Finally, as can be seen by the above description, prior to the present invention the preparation needed to conduct a mock trial necessitated that detailed advanced planning was needed in order to ensure that the mock trial could be conducted prior to the actual trial or settlement negotiations. Coordination amongst the participants was vital and often the timing was preclusively restrictive because of the reduced dates that all participants could get together in one central location. Previous attempts to overcome the logistical and transactional costs associated with conducting a mock trial for trial research purposes have fallen short. The first of these attempts was to “teleconference” many of the participants into the mock trial system. This involved teleconferencing witnesses and counsel in the mock trial. While saving the transportation costs associated with travel, these costs savings were minimal compared to the overall cost to the mock trial. Teleconferencing still required that a full-scale mock trial be conducted in a central location generally where the trier of fact resided. Additionally, by teleconferencing counsel or witnesses into the process, jurors were often left viewing only the telephone and often times could not accurately judge the witness's credibility.

Teleconferencing still necessitated going to the forum where the trial was to occur and to gather all of the triers of fact from that location and bring most of the participants and exhibits to that location. This was simply because of the logistical constraints placed on teleconferencing. In short, the more participants that teleconferenced into the mock trial, the more coordination was needed to ensure that all participants were teleconferenced at the appropriate time and the more coordination was needed to ensure that all participants were participating in a functionally sensible way.

Further, it soon became obvious that the jurors could not be individually teleconferenced together for the mock trial. Because of the uncoordinated aspects of the jury deliberations, jurors needed to be able to address other jurors instantaneously. While teleconferencing allows jurors to voice their opinions often jurors would become confused as to which juror was voicing what opinion. Additionally, when the jurors were teleconferenced into the mock trial, the researchers lost the ability to “observe” the jury and keep track of individual jurors' opinions. The researcher needed to be able to coordinate jurors' opinions with individual jurors. Thus, if a jury scientist was using a large jury pool for the mock trial, this might necessitate over 50 participants attempting to “patch” into a teleconference if all triers of fact were not centrally located. Beyond the logistical nightmare that this might cause, it was clear that it would be impossible to individually address teleconferenced jurors because of the potential numbers involved. It was quickly discovered that teleconferencing provided minimal savings in travel cost, but maximized logistical costs resulting in an overall increase in actual mock trial costs, and often reduced predictive results.

Hence, there existed in the art a need to increase costs savings of conducting a mock trial, while maintaining or increasing the predictive result and maintaining or increasing the flexibility afforded by a mock trial. This need encompasses the need to conduct a mock trial by jury scientists, in a cost effective manner, free from geographic constraints, and free from logistical constraints, while still providing at least as accurate a prediction of the clients exposure. This need is clearly felt in the art, and is solved by the present invention.

### SUMMARY OF THE INVENTION

The present invention addresses the above-described needs. The present invention provides for a methodology to conduct virtual mock trials and focus groups utilizing the Internet as a communication medium between jurors, parties and jury scientists. This methodology allows the virtual mock trial to be conducted at various locations at the same time in a virtual courtroom, providing a unified “location” where all participants congregate during the course of the virtual mock trial. This methodology allows for the jury pool to cover the entire country for any particular virtual mock trial, thus freeing the jury scientists from the constraints of any particular physical forum. Additionally, this methodology allows the virtual mock jurors to view the case either real time or at a later time. Further, the present invention provides for a virtual Courtroom in which the mock jurors receive the testimony, evidence, arguments, and jury charge; a virtual Jury Room for virtual jury deliberations by the virtual jurors, and a virtual Observation Room whereby the jury scientist and lawyers can view the Jury Room deliberations behind an “Electronic One-way Mirror.” The present invention provides that the jury scientist may “whisper” to virtual jurors in the Jury Room in order to conduct research as the deliberations are occurring. Voting by the virtual jurors can be taken either anonymously or openly such that other jurors will be aware of each person's vote. The present invention can also be used as a methodology for conducting a virtual trial with a virtual judge presiding over a case between two parties. A virtual jury may observe the virtual trial either real time or at a later time and decide the case in the similar manner as described above.

The present invention can also be used as a methodology for conducting a virtual arbitration proceeding or a virtual summary jury trial utilizing similar methodologies as described above. The present invention can be utilized by jury scientists to provide a virtual gallery jury for ongoing trials utilizing similar methodologies as described above.

The present invention can be used to test and measure jurors reactions to various trial exhibits, graphics, counsel's arguments and the like using video streaming to allow the virtual jurors to view the material either real time or at a time of the trial scientists choosing.

The present invention allows a trial scientist to forecast jury verdicts for their clients, by taking the virtual jurors voting patterns and using methods within the art, to develop probabilities associated with each cause of action and therefore forecast the damages, if any, that may be assessed against the client in a more accurate manner.

The present invention allows the trial scientist to study the selection process of an actual jury being chosen and mirror the process being used to ensure that an adequate representative sample of the trier of fact is presented for to the client via the Internet.

The present invention allows can be adapted for either civil or criminal cases. In criminal cases the present invention will be used to provide a predictive result to the guilt or innocence of the party and the possible sentencing imposed, allowing for better plea bargaining to occur.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a flow chart describing an overview of the present invention;

FIG. 2 is a flow chart describing one aspect of the present invention, namely the methodology of readying the case for presentation;

FIG. 3 is a flow chart describing one aspect of the present invention, namely the methodology of using the Observation Room;

FIG. 4 is a flow chart describing one aspect of the present invention, namely the methodology of using the Jury Room;

FIG. 5 is an example of a computer screen as seen by a participant in the Observation Room;

FIG. 6 is an example of a computer screen as seen by a participant in the Jury Room;

FIG. 7 is a flow chart describing one embodiment of the present invention, namely the conducting a virtual jury trial;

FIG. 8 is a flow chart describing one embodiment of the present invention, namely the conducting of a virtual gallery jury;

FIG. 9 is a flow chart describing one embodiment of the present invention, namely the conducting of alternative dispute resolution;

FIG. 10 is a flow chart describing one aspect of the present invention, namely the methodology of selecting a jury panel;

FIG. 11 is an example of a computer screen as seen by an applicant;

FIG. 12 illustrates, in block diagram form, a communication system in accordance with one embodiment of the present invention; and

FIG. 13 illustrates, in block diagram form, a data processing system implemented in accordance with one embodiment of the present invention.

### DETAILED DESCRIPTION OF THE INVENTION

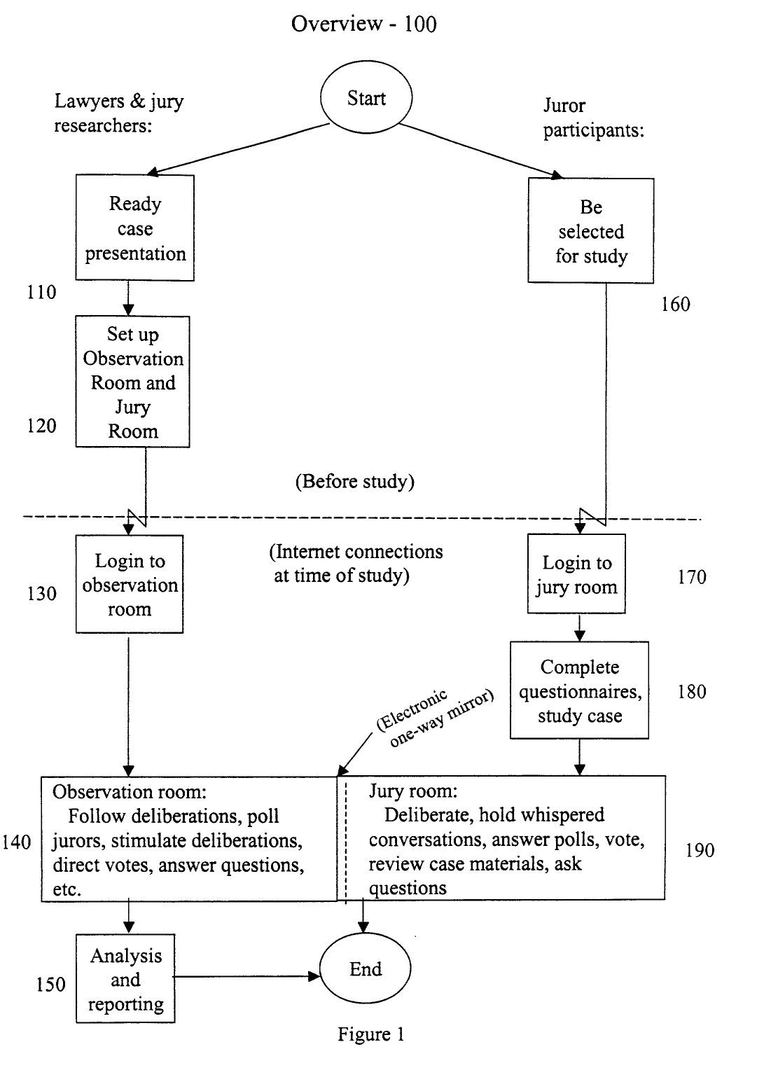

The principles of the present invention and their advantages are best understood by referring to the illustrated embodiment depicted in FIGS. 1-_of the drawings, in which like numbers designate like parts. In the following description, well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

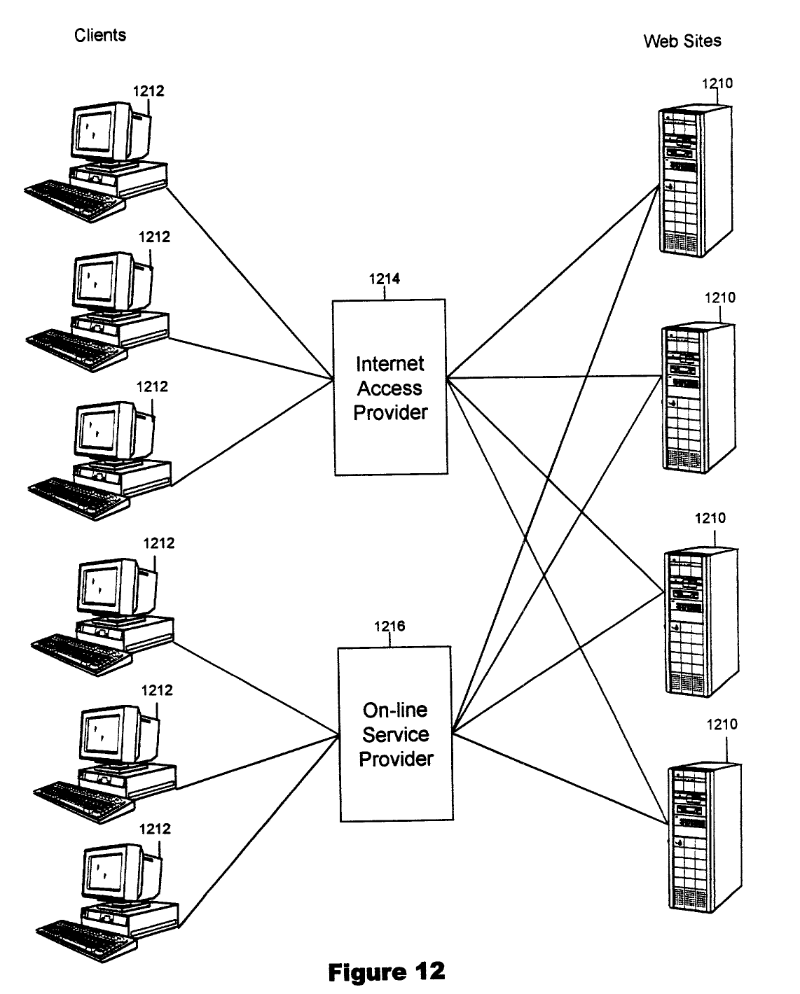

FIG. 12 illustrates a communication network based on a client-server model typically utilized in the Internet. The subsequent discussion and description of FIG. 12 are provided to illustrate the Internet environment utilized by the present invention.

Conceptually, the Internet comprises a large network of “servers” 1210 that are accessible by “clients” 1212. Each of the plurality of clients 1212 is typically a user of a personal computer. Clients 1212 access the Internet through some private Internet access provider 1214 (such as Internet America™) or an on-line service provider 1216 (such as America On-LineTM, AT&T WorldNet™, and the like). Each of clients 1212 may run on a “browser,” which is a known software tool used to access the servers (1210) via the access providers (1214 and 1216). Each server 1210 selectively operates a “web site” that supports files in the form of documents and pages. A network path to a server is identified by a uniform resource locator (URL) aving a known syntax for defining a network connection.

As previously mentioned, the World Wide Web is a collection of servers on the Internet that utilizes Hyper Text Transfer Protocol (HTTP). HTTP is a known application protocol that provides users access to files using a standard page description language known as Hyper Text MarkUp Language (HTML). It should be noted that the files may be in different formats, such as text, graphics, images, sound, video, and the like. HTML provides basic document formatting and allows the developer to specify “links” to other servers or files. Use of an HTML-compliant browser involves specification of a link via the URL. Upon such specification, one of the clients 1212 may make TCP/IP request to one of plurality of servers 1210 identified in the link and receive a web page (specifically, a document formatted according to HTML) in return.

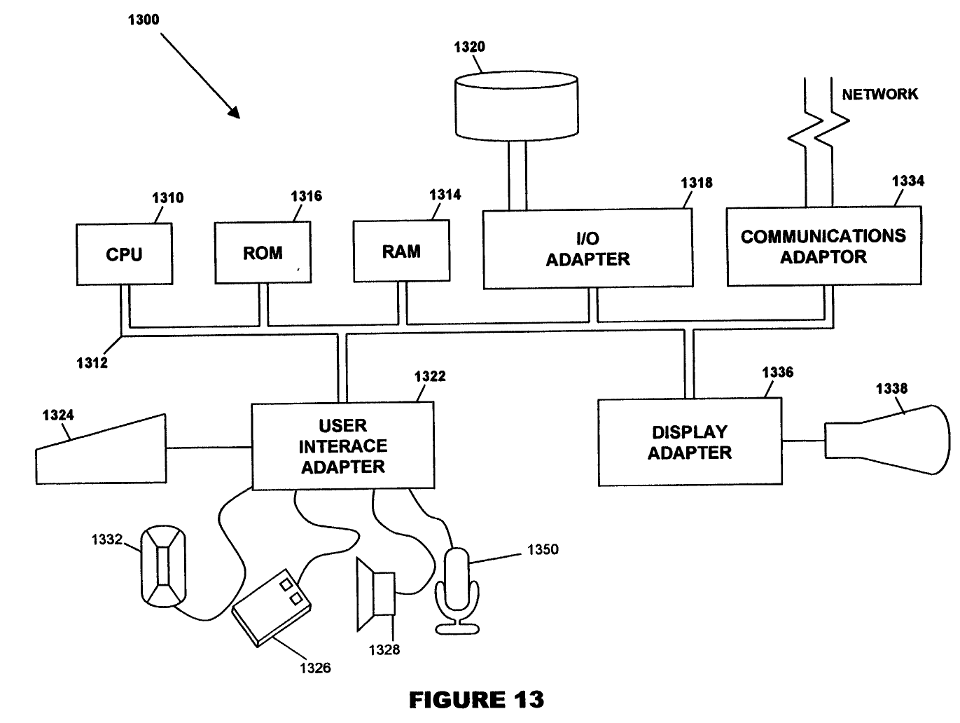

FIG. 13 illustrates a data processor 1300 that may be utilized to implement a “client” (1212) that executes the methodology of the present invention. Data processing system 1300 comprises a central processing unit (CPU) 1310, such as a microprocessor. CPU 1310 is coupled to various other components via System bus 1312. Read-only memory (ROM) 1316 is coupled to the System bus 1312 and includes a basic input/output system (BIOS) that controls certain basic functions of the data processing system 1300. Random access memory (RAM) 1314, I/O adapter 1318, and communications adapter 1334 are also coupled to System bus 1312. I/O 1318 may be a small computer system interface (SCSI) adapter that communicates with a disk storage device 1320. Communications adapter 1334 interconnects bus 1312 with an outside network enabling the data processing system to communicate with other such systems. Input/output devices are also connected to System bus 1312 via user interface adapter 1322 and display adapter 1336. Keyboard 1324, trackball 1332, mouse 1326, and speaker 1328 are all interconnected to bus 1312 via user interface adapter 1322. Display monitor 1338 is coupled to system bus 1312 by display adapter 1336. In this manner, a user is capable of inputting to the system through keyboard 1324, trackball 1332, or mouse 1326, and receiving output from the system via speaker 1328 and display 1338.

Some embodiments of the invention include implementations as a computer system program to execute the method or methods described herein, and as a computer program product. According to the computer system implementation, sets of instructions for executing the method or methods are resident in RAM 214 of one or more computer systems configured generally as described above. Until required by the computer system, the set of instructions may be stored as a computer program product in another computer memory. For example, in disk drive 1320 (which may include a removable memory such as an optical disk or floppy disk for eventual use in disk drive 1320).

Further, the computer program product can also be stored at another computer and transmitted in a computer readable medium when desired to the user's work station by a network or by an external network such as the Internet. One skilled in the art would appreciate that the physical storage of the sets of instructions physically changes the medium upon which it is stored so that the medium carries computer-readable information. The change may be electrical, magnetic, chemical, or some other physical change. While it is convenient to describe the invention in terms of instructions, symbols, characters, or the like, the reader should remember that all of these and similar terms should be associated with the appropriate physical elements.

Note that the invention describes terms such as comparing, validating, selecting, entering, or other terms that could be associated with the human operator. However, at least for a number of the operations described herein which form a part of the present invention, no action by a human operator is desirable. The operations described are, in large part, machine operations processing electrical signals to generate other electrical signals.

The foregoing has provided a general description of a communication environment that implements one embodiment of the present invention. Execution and operation of the present invention will subsequently be described in greater detail with respect to each of FIGS. 1 through 11. As previously mentioned, the data processing system of the present invention generates a web-browsing history. The web-browsing history so generated voids duplication of repeatedly visited sites, and allows for random access to previously visited web pages. A description of operation of the data processing system and methodology of the present invention will now be provided in greater detail.

FIG. 1 illustrates an overview of the methodology, in flowchart form, of the present invention. In FIG. 1, the client, usually through counsel, requests a jury scientist or researcher to prepare a virtual mock jury in step 100.

It is important to note that this methodology can be used for either criminal or civil cases. In criminal cases, the methodology would be used to provide the client with juror's verdict as to a party's guilt or innocence and provide for a possible sentencing. This allows the client to enter into plea negotiations with more accurate information. For purposes of the below discussion, a civil case will be used for brevity. Additionally, the present invention allows for forecasting of jury verdicts. The present invention allows the trial scientist to account for voting probabilities and associate them with the results of the virtual mock trial and associate the predictions with each cause of action and forecast what damages, if any, that the client might face during trial.

In step 110 the jury scientist readies the case for presentation. The jury scientist and the trial lawyers work together to develop the screens, images, videos, and audio clips that will present the case information to the virtual triers of fact (hereafter collectively called “jurors”). This presentation may be based on various trial strategies and may utilize case summaries written by the lawyers. It may also include video-deposition testimony taken from key witnesses for video streaming, expert reports, documents retrieved during discovery, photographs of physical evidence and locations, computer reconstructions of events, graphic exhibits, audio-recorded statements by witnesses and lawyers, and videotape recordings of statements and lawyer arguments, and flexible implementation of video stream of real time events and arguments.

Next, the case presentation is stored into the memory of the computer or server that will support the virtual mock jury process. For example, if hypertext transmission protocol (“http”) and hypertext mark-up language (“html”) on the World Wide Web, or Web (“WWW”) is to support the virtual mock trial process, then the various documents, descriptions, photographs, video- and audio-recordings, etc., described in step 110 would be transferred to the proper http file formats (e.g., .html, jpeg, .txt, .ra). If another graphical user interface (“GUI”) is used to support the virtual mock trial, then transfers would be made to the file formats appropriate for that GUI. The various information-containing files consist of the “exhibits” for the virtual mock trial. This process is technical rather than logical and analytic. It requires technical knowledge and skills and is likely accomplished by a technician and is within those skilled in the art of the necessary language protocols. This process uses the technology and practices of the on-line computer system that is being used to support the virtual mock trial process.

After the jury scientist prepares the case presentation in step 110, the jury scientist prepares the structure of the virtual jury room. It is here that the researcher makes the decisions on how the jurors will interact amongst themselves and with the researcher during the virtual mock trial. Additionally, the researcher will coordinate with the client the structure of the virtual observation room and the electronic one-way mirror.

Finally, during step 120, the researcher will select the location of the login site. If this occurs in a web based format, then the location will be a Uniform Resource Locator (“URL”). This URL may be a central location that all virtual jurors access for various mock trials or may be specific to the virtual mock trial, depending on the researcher's preference. Thereafter, at the specified location and time in step 130, the lawyers who will be presenting the case and the jury scientist that will be overseeing the virtual mock jury login to the observation room.

Prior to commencing a virtual mock trial, the jury scientist selects a suitable number of virtual jurors in step 160. Because of the structure of the present invention, for the first time jurors are not required to be in one central location during the virtual mock trial. This necessarily implies that the jury scientist is not limited to choosing the virtual juror from the forum where the case is pending. As those skilled in the art will recognize, the jury scientist will be able to find substitute jurors from different forums that exhibit the characteristics of those from the chose forum.

Free from this restriction, the jury scientist may choose from among thousands or tens of thousands of juror applicants to participate in the virtual mock trial. This allows the jury scientist to construct the juror based on various behavioral patterns exhibited in the chose forum rather than just based on physical location. By constructing the virtual jury in this manner, the jury scientist can test the various themes on jurors with differing behavioral patterns, allowing the researcher to evaluate the reaction that the various trial techniques have on differing jurors. Once a suitable “pool” of potential jurors are chosen by the researcher, the researcher then contacts the members of that pool by various methods, including e-mail, providing them with the date, time and URL location for the virtual mock trial. Usually the researcher will contact the virtual juror by e-mail, requesting a reply as to the availability of that juror for the virtual mock trial in question. This allows nearly instantaneous replies to the trial researcher ensuring that an adequate number of jurors “appear” for the virtual mock trial.

Additionally, because the jurors do not need to be at a central location, the timing for the virtual mock trial is open to any time that the researcher can gather an adequate number of virtual jurors. Thus, the virtual mock trial can occur in the evenings or any other convenient time. Again, because the virtual jurors do not need to be at a central location, the researcher can “pool” the jury from across the country, thus ensuring that a virtual jury can be empaneled at the specified time. This aspect of the invention presents important implications for conducting of a virtual mock jury. Most importantly, a client can make a request to jury scientist for an immediate virtual mock trial. Because the researcher can choose from a data base of thousands of potential jurors from across the country, the jury scientist will be able to quorum a jury almost immediately, allowing the jury scientist to provide nearly real time jury science methodology to the clients. Additionally, the costs associated with quorumming a jury in one central location disappear. Therefore, regardless of the time constraints, the cost for providing the service will not be juror dependent.

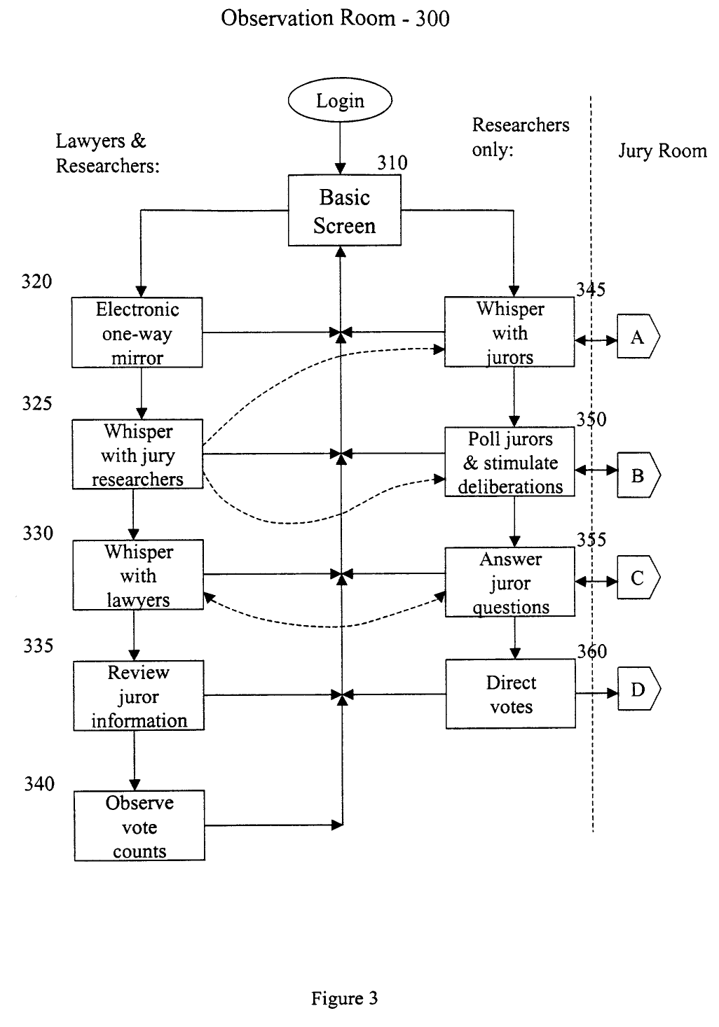

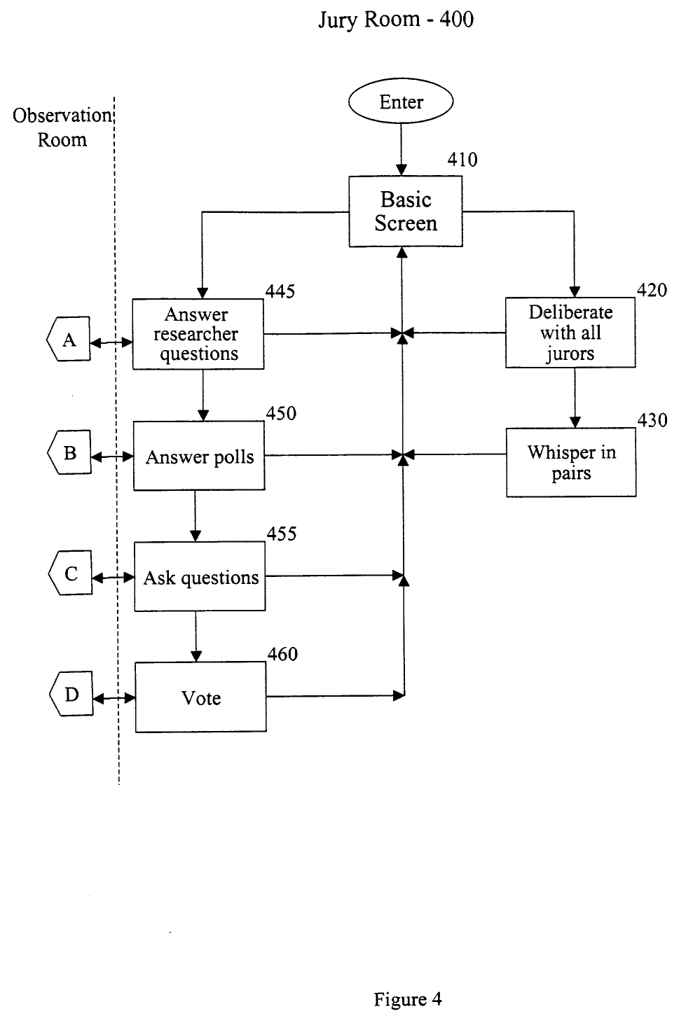

Once the jury scientist contacts the selected “pool” of jurors and a response is received from those jurors indicating their acceptance to appear as a virtual jury member during the virtual mock trial, the juror will be informed as to the time, date and location for the virtual mock trial. Subsequently, at the appropriate time, the juror will log in to the Jury Room in step 170. At the same time, the client, his lawyers and the jury scientists will login to the Observation Room in step 130. The Observation Room in step 140 is a collection of computer display screens that allows the lawyers and jury scientists to observe and direct the virtual mock trial process. The detail flowchart in FIG. 3 addressing the Observation Room and FIG. 4 addressing Jury Room is described below in greater detail and shows the logic and function of this part of the virtual mock trial system.

Conceptually, several processes occur in the main Observation Room screen in step 140. Refer now to FIG. 3 and FIG. 4 where is shown the methodology employed in flow chart form for Observation Room 140 and Jury Room 190. The most important and unique aspect of the Observation Room is the “Electronic One-Way Mirror”320. 320 allows the deliberations occurring amongst the jurors in Step 420, and “whispers” between pairs of jurors in Step 420, to be observed by the jury scientist and lawyers without the knowledge of the jurors. The jury scientist and attorneys by viewing the deliberations of the jurors behind the Electronic One-Way Mirror gain insight into the juror's thought process. From the Observation Room, each message or statement from any juror, or from the scientists to the jurors, is labeled with the source juror of the message. These labels will contain links to information about the individual juror making the message or statement. This allows the jury scientist to immediately identify the characteristics of the juror speaking allowing the jury scientist to gain more insight into how the juror's comments can be interpreted based on juror behavioral characteristics.

Another function of the Observation Room is communication flow from the lawyers and jury scientists. Lawyers may communicate with each other In Step 330 and the jury scientists in Step 325 while the jury is deliberating in Step 420 by typing messages on the screen and clicking the “Whisper with Researcher” or “Whisper with Lawyers” function. All lawyers and jury scientists see these messages, but no jurors see them. Additionally, jury scientists may communicate in the same manner as the lawyers, but they also may send messages to the jurors in Step 345, 350, 445-460.

Importantly, the Observation Room allows the jury scientists to “whisper” to jurors one at a time during the deliberation process without the knowledge of the other jurors in Step 345. This is done by typing into the whisper screen (or text-field) and clicking the “Whisper with Jurors” function. The whisper function also allows two jurors to communicate privately with each other in the Jury Room (although still observed by the Electronic One-Way Mirror) in Step 430. When jurors or scientists initiate whispers, they click on the whisper function on the main Observation Room screen or Jury Room screen. This takes them to the special Whisper screen. The whisper screen allows them to select the person they wish to communicate to by simply clicking the field identifier representing the person they wish to contact privately. It also allows them to type in the initial message. They then click the “send message” function.

The targets of the whisper communication are then supplied with a Whisper screen that “pops-up” when the whisper function is initiated with them. Here, they see who is communicating with them and the initial message. They may then type their reply if they so desire. Once their reply is composed, they click the “Send Message” or “No Reply” function, and return to the main rooms. This back-and-forth message sending continues until one person selects the “No Reply.” A person can be whispered to by more than one person at a time thus conducting multiple whisper sessions simultaneously. However, if no reply is made in a minute or two, then an automatic “No Reply” is generated. Automatic no replies happen when whispers are not heard by a person.

The present invention allows juror to view the material while in the Observation Room if the trial scientists configures it properly. This will allow the jurors to view materials while they are discussing them. Additionally, if the trial scientist so chooses, the present invention can be implemented such that jurors can view material via video streaming and record their reaction real time. This allows the trial scientist to more accurately determine the effect of a particular exhibit, counsel's argument, or witness examination on the jurors, and to test various theories and arguments on the virtual jurors while they are examining the material real time.

Referring now to FIGS. 3 and 4, upon entering the Observation Room, the lawyers and researchers will view a basic screen at Step 310, and the jurors upon entering the Jury Room will view the Jury Room basic screen at Step 410. The lawyers and researchers can view the Jury Room in Step 320. The Jury Room will consist of the deliberations occurring amongst all jurors in Step 420. Additionally, if jurors decide to whisper amongst themselves in Step 330, the lawyers in Step 320 will be able to view this through the one-way mirror. During the deliberations the lawyers and researchers may wish to deliberate amongst themselves or with each other in Steps 325 and 330. As a result of the whispers amongst the lawyers and researchers, the researchers may decide to whisper with a juror in Step 345, querying a specific juror about a response or his feeling about a particular mock trial subject. The juror will answer the researchers' whisper in Step 445. Alternatively, the researcher may decide to poll jurors or to stimulate deliberations towards a direction where the jurors have not explored in Step 350. The jurors will reply to the researchers' poll or questions in Step 450. Furthermore, in Step 455 the jurors may decide to ask a question of the “Bailiff” or researchers in Step 455 concerning a specific exhibit, ruling or procedure in the mock trial. The researcher will be able to answer the juror's question in Step 355. During the progression of the deliberations as stated above, if a lawyer or researcher is interested in a specific juror's background information, he may view this in Step 355. Finally, at the end of the deliberations or if the researcher so chooses during the progress of the deliberations, the researcher may direct votes to the jurors in order to better understand their position. This occurs in Step 360, and the jurors will vote in Step 460. The deliberation in the Jury Room will occur in this manner, with the lawyers and researchers observing in the Observation Room until the deliberations have concluded.

It is important to note that the present invention allows for anonymous voting or polling of the virtual jurors. This implementation of the present invention allows the juror to respond without knowing his fellow jurors' response and provides the trial scientist with additional information on how juror interaction occurs. Upon logging in to the Jury Room in Step 170, the jurors must complete a questionnaire and study the case in Step 180. The questionnaires provide basic information concerning the case, and inform the juror of what to expect. After completing the questionnaires, the case presentation prepared in Step 110 will be viewed by the jurors in Step 180. This involves the jurors viewing the various trial exhibits, witnesses, opening and closing arguments, and any other portion of the virtual mock trial that the lawyers and researchers have prepared for the jurors. Upon completion of reviewing the necessary elements of the case, the jurors will then enter the Jury Room. It is important to note that because of the methodology utilized in the present invention, it is not necessarily important that the jurors study the case and complete the questionnaires at the same time. In fact, because of the present invention, the jurors can be notified of the date, time and location that they are required to enter the Jury Room having completed the questionnaire and studying the case. In this manner, the jurors need only gather at the same time in the Jury Room, after all jurors have viewed the case. This allows the jurors to complete Step 180 at their leisure prior to entering the Jury Room. This provides for a more efficient coordination of the Virtual Mock Jury, because many time in the past all jurors were not able to be present during the presentation of the case, and to complete the questionnaires. The set-up of the Complete Questionnaires and Study Case for step 180 screens and the Jury Room screens for step 190 requires the programming of the computer support system and modification of the “blank case” screens. For example, when http and html are used to support the virtual mock trial process, then the list of case exhibits on the Study Case screens in step 180 must be modified to reflect the case under study, and URLs (universal resource locator) links to the files with the exhibits. With other on-line systems, links must still be made with the appropriate command language.

The complete process of preparing the Complete Questionnaires and Study Case screens for step 180 and the Jury Room screens for step 190 must be completed before the virtual mock trial study can be conducted. The Login to Observation Room function in step 130 and the Login to Jury Room function in step 170 will occur on the same day. The Login to Jury Room function in step 170 will generally occur prior to the lawyers logging in to the Observation Room in step 130 since the jurors must complete questionnaires and study the case materials. The jury scientist leading the virtual mock trial study will login earlier in step 130 so as to follow the arrival of the jurors into the Jury Room as they login in step 170. A jury scientist may conduct a polling session with the jurors, and polling the jurors is a function available only to the scientists. This allows the scientists to force all jurors into the whisper mode with the scientist alone. When the scientists select the “Poll the Jury” function, they go to the Whisper screen, but they can select “All Jurors.” They then type their instructions, messages, or questions to the jurors. The scientists can either select “Reply Required” or “Reply Optional.” When replies are required, jurors cannot select the “No Reply” function on their Whisper screens. Polling the jurors is a function used by the researchers to obtain answers to specific parts of the deliberations, or to specific exhibits. It can also be used to stimulate or direct the deliberations in specific directions.

Jurors can use the Whisper function to ask questions of the scientist (also called “bailiff” or “judge”). In these cases, the scientist may either make a private reply, or may use the “Poll the Jury” function with “Reply Optional” to answer the question so all jurors may learn the answer.

Another function available only to scientists is the “Direct the Vote.” The “Make Vote” functions on the Jury Room screens of the jurors may be deactivated by the scientist. This is often used to delay the vote while all of the jurors are logging into the Jury Room. It can also be used to progress the voting from question to question, because the scientist can change the question upon which the jurors are voting.

The “Direct the Vote” screen allows the scientist to type in new questions and instructions to the jurors. The scientist can select the “Must Vote” function which forces all jurors to vote (or vote again) before returning to the Jury Room. This will typically occur when the researcher wants to take a final vote on an issue. The scientist will change the question's instructions to tell the jurors that this is a final vote and then use the “Must Vote” function. The scientist can change to the next question, and use the Polling screen with the “Optional Reply” function to tell the jurors that a new question or issue is under consideration.

After the deliberations have been completed, the jury scientists review and compile the results of the virtual mock jury and form the compilations into a report document for the lawyers and their clients. The present invention allows for this report to be as detailed as the client wishes. Because all communications are occurring through a common server, the entire virtual mock jury is recorded in real time. This allows for a detail analysis to be quickly provided to the client. The report can then be e-mailed and faxed to the lawyers.

The process by which jurors are selected for participation in a virtual mock trial study is detailed in a separate flowchart.

When the jurors are selected they are given a password that allows them to login to the Jury Room. They are also directed as to the time and computer interface they must use. For example, when the WWW is used to support the virtual mock trial process, then jurors are given the appropriate URL to use to enter the Jury Room.

The password identifies the jurors and ensures that only the proper jurors are participating in the deliberations. Once the appropriate time and date arrives, the juror logs into the Courtroom at step 170.

After the jurors successfully log in step 170 to the Courtroom, they proceed through a series of mandatory screens that administer the Jury Questionnaire to the jurors in step 180. The Jury Questionnaire obtains initial baseline attitudinal measures, and also serves the purpose of giving the jurors the basic information about the case.

The questionnaires require that all mandatory items be completed before they are accepted and the jurors are allowed to proceed to the Jury Room. When jurors fail to complete mandatory information items, they are shown an error message and asked to complete the items successfully. The basic contents of the questionnaires are presented elsewhere. Scientists can modify the questionnaires on a case by case basis.

The exhibits prepared in Ready Case Presentation are presented to the jurors during Step 180 prior to entering the Jury Room. Upon completion of viewing the materials, the jurors then enter the Jury Room. However, the jurors may still review the materials from the case in the Jury Room. One of the Jury Room functions allows the jurors to return to the exhibits when they wish to review the information in them by means of an index of links. Part of the display in the Electronic One-Way Mirror shows which jurors return to an exhibit and which exhibit was reviewed. This allows analysis of the relative importance or difficulty of each exhibit.

When jurors review documents, photographs, and other exhibits in step 180, they are asked to make a numerical rating (1 to 9) about the information quality of the item displayed. In those cases where jurors are shown streaming videos of witnesses or lawyers arguments, they are asked to make a numerical rating of the credibility of the witness and the strength of the argument. These ratings are tabulated during the analysis of the process, step 150, and the results are superimposed on the item for reporting purposes.

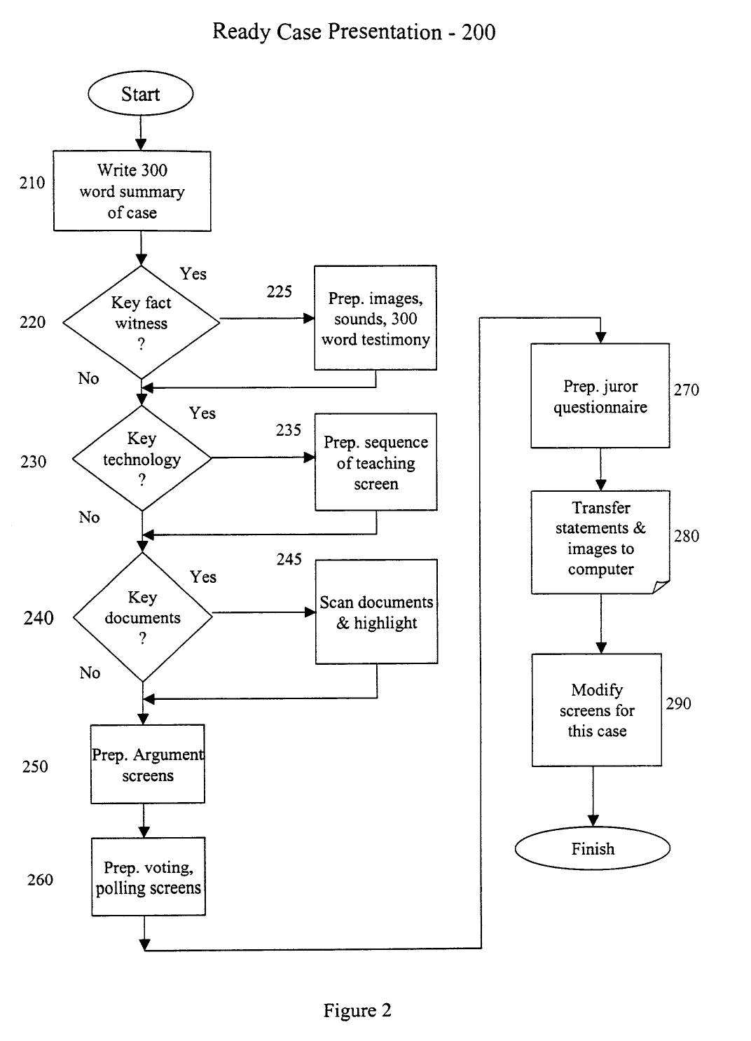

FIG. 2 shows the methodology how the jury scientist prepares the case for presentation in step 110 in flowchart form. Once a client requests a virtual mock trial session, the jury scientist begins by writing a 300 word summary of case in step 210. This opening in presenting a case to jurors is a short statement about who the parties are and what the main complaints or disputes are. This provides the introduction to the case.

Next the jury scientist prepares the key fact witnesses. Some trials involve key fact witnesses, i.e., a criminal trial where there is an eye witness, or the victim and the perpetrator in a sexual harassment suit. There are several ways that fact witnesses can be presented to the jurors in step 180 in the virtual mock trial system. A live image carried over the Internet of the witness with sound is the preferred method. A streaming video-image of the witness with sound is another method. Alternatives are streaming video segments coupled with a non-synchronized sound presentation of the witnesses' testimonies. Still photographs and written statements are other methods. In any scenario, the researcher must decide what is most appropriate for that particular virtual mock trial, and prepare the screen arrangement and file formats for the jurors to view. This is done in Step 220.

An important part of preparing key fact witness testimony is to communicate the information from the witnesses, and their points of view, without producing too strong a bias for or against a party to the lawsuit. However, it is important, when readying the case in step 220, to ensure that the information is stored, when necessary, on the appropriate computer, so that the case presentation operates smoothly. Jury scientists provide this skill.

Just as there are key witnesses, some lawsuits involve key technological, scientific, or professional information. Thus, the key technology must be prepared in step 230. Examples of cases where key technology is important include toxic tort cases where the medical and scientific information is central to the case. Commercial cases often require technological knowledge of accounting or business methods. The jury scientist will decide the most appropriate method to supply this information to the jurors as he did in Step 230.

If there is key technology in a case, then teaching screens need to be prepared to teach the jurors about the science and technology that the trial jurors would learn from the expert witnesses. These screens include text definitions, graphical images, flowcharts, photographs, maps, etc.

When there are key documents in the case, the virtual mock trial process has the applicable part of the documents scanned and the operative phrases highlighted for the jurors. This is accomplished in step 240. When indicated, the title of the document, and information about it is added in a caption. Some of the screens in the case presentation present the arguments and prayers of the parties. This is accomplished in step 250. These may need to be summarized in non-technical language for presentation for the juror. Generally, the virtual mock trial system presents one or two arguments per screen.

The jurors are asked to vote on the issues in the case and to answer questions when the jury scientist polls them. The screens containing these questions and polls can be prepared before the start of the virtual mock trial. This occurs in step 260.

The virtual mock trial system contains a standard juror questionnaire that is answered by each juror as they enter the virtual mock trial Jury Room. However, additions or deletions can modify this standard questionnaire. How these changes are made depends on the computer platform upon which the virtual mock trial is implemented. For example, if the virtual mock trial system is being implemented with the WWW (World Wide Web) technologies of hypertext transmission protocol (“http”) and hypertext markup language (“html”), then the hypertext forms used to present the jury questionnaires would need to be changed by deleting those text fields and controls which produce the unwanted part of the questionnaire and adding text fields and controls to produce any additions. The jury scientist would accomplish this in step 270.

The statements, images, videos, sound-bytes, charts, questionnaires, etc., that are prepared to present the case must be converted to computer data files if they are not already this type of information. This is a technical function and may be done by someone other than a jury scientist in step 280.

The final step in preparing the case for presentation in the virtual mock trial system is to modify the basic information presenting screens of the computer program that supports the virtual mock trial process. These screens have to have the correct links on them to present the files made in the previous steps. For example, if the virtual mock trial system were being implemented with the WWW technologies of http and html, then the documents and files would have to be listed on index pages and html links written to the actual files.

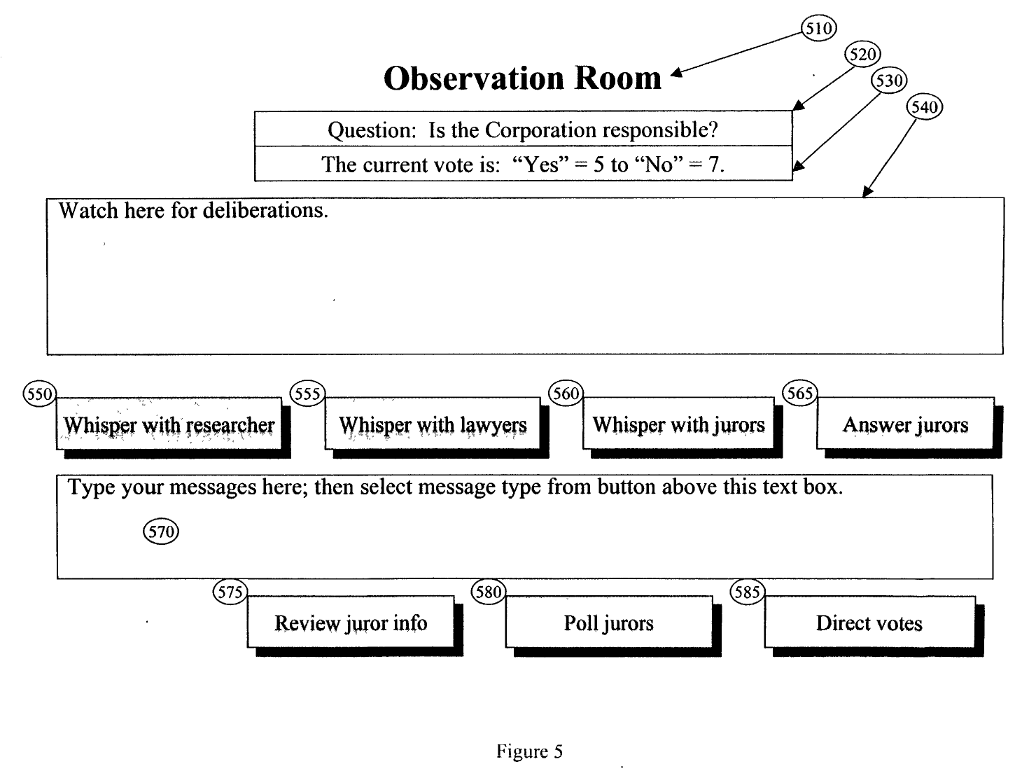

FIG. 5 illustrates a representative sample of the observation room as observed from a computer screen. These screens are designed to operate over http and html with javascript and java support. Other graphical interfaces in on-line courseware programs can support the virtual mock trial system.

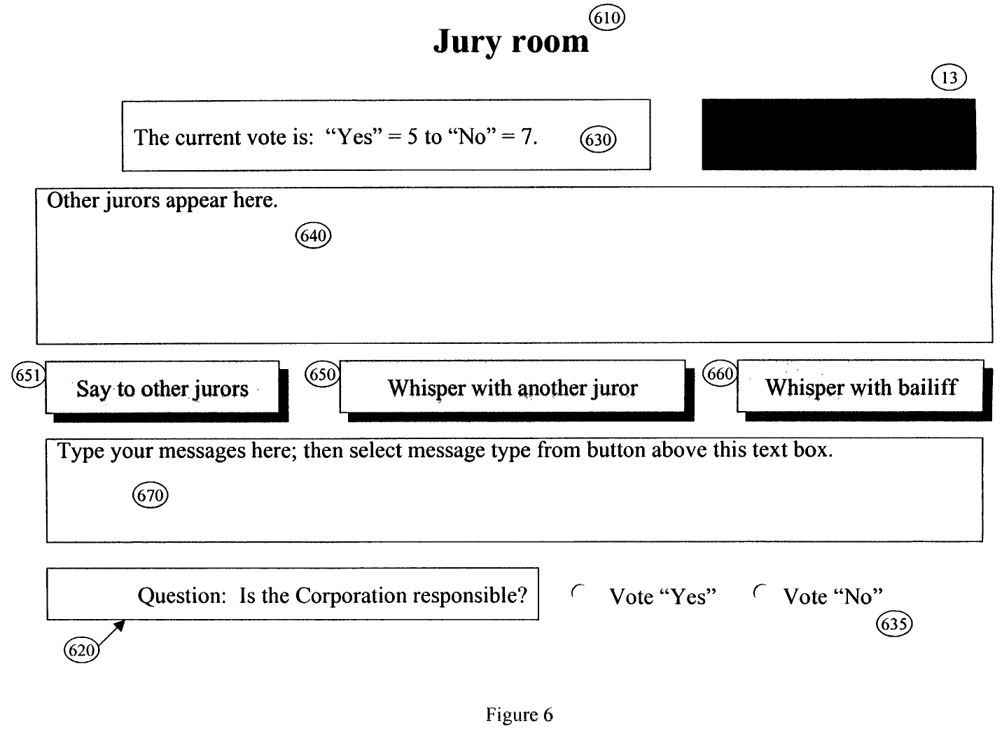

When the virtual mock trial system is being used to conduct juror research about a law suit, the lawyers and jury scientist involved use the Observation Room screen and the jurors will use the Jury Room screen described below in FIG. 6 during the course of the jury deliberations. While both the lawyers and the researchers utilize the Observation Room screen, only jury scientist have the function enabled that allow them to communicate with the jurors directly during the deliberations, for example, the “Whisper with the Jurors” or the Poll the Jurors″ functions.

In FIG. 5 of the Observation Room screen, the title of the room where the jury scientist is located is displayed at 510. When the jury scientist decides to present a question to the trier of fact, this question is displayed at 520, and a current tally of the triers of facts responses occurs at 530. The jury scientist and lawyer watch the jurors deliberate in real time in space 540. In fact, 540 functions as an Electronic One-way Mirror allowing the lawyers and researchers to monitor the deliberations without the jurors' knowing of their presence. Additionally, function keys 550, 555, 560, 565, 575, 580 and 585 appear in the Observation Room for the jury scientist and will be discussed below. When the jury scientist wants to contribute to the deliberations or utilize the functions listed on his screens, the jury scientist will type in space 570 and press the appropriate function button when he is ready to send his message.

There are several “whisper” functions in the virtual mock trial system. This is an analog to the event during a traditional focus group or jury deliberation where two jurors or participants whisper privately to each other rather than to the whole group. While in the past researchers were not always able to hear what jurors were whispering to each other, in the virtual mock trial system this function allows the jury scientists to observe real time as the whispers occur allowing them to become more intimately involved during the process. Thus, the whisper function in the virtual jury system increases the information flow to the researcher and allows the jury scientist to study clique formation among the jurors, in greater detail than would be allowed in the past.

The Observation Room screen may differ depending on who is observing the virtual mock trial at that particular screen. For example, FIG. 500 shows the Observation Room screen for the jury scientist, which allows the jury scientist to whisper with another researcher at 550, with another lawyer at 555, with an appropriate juror at 560, or answer one of the juror's questions at 565. However, the Observation Room screen may be modified such that an observer such as the client will only be able to whisper with the researcher or with his lawyer. Thus the client's observation screen may not have buttons 560 and 565, thus forcing the client to present his questions first to the jury scientist and allowing the jury scientist to control the flow of information to and from the jurors.

In the present example, the “Whisper with the Researcher” command, 550, allows private conversations with any combination of lawyers and researchers logged on to the Observation Room. As described above, when a “Whisper with the Researcher” is requested, a separate screen will appear on the Observation Room both for the person requesting the whisper session with the researcher and with the researcher. This allows each participant to separately engage in a conversation while remaining in the Observation Room to observe the real time deliberations with the jurors.

The “Whisper with the Lawyers” button, 555, is functionally the same as 550. The same holds true for buttons 560 and 565. The different command buttons are provided to increase the intuitive operation of the Observation Screen.

The “Whisper with the Jurors” command 560, is only available to the jury scientist. It allows any jurors, or combination of jurors to be addressed by the jury scientist. When command 560 is selected, the researcher can also select “Response Required” which forces the jurors to select an answer before continuing with the deliberation.

Whispering occurs on a separate whisper screen that appears off to the side of that person's main screen once the command is enabled. However, all messages whispered to and from the jurors are also displayed on the Electronic One-way Mirror field in the Observation Room. These whispers are captured in the log file, unless the researcher disables the function. Whispers among lawyers and researchers do not appear on the Electronic One-way Mirror, as they are viewable on the lawyers' and the researchers' particular observation screen. Unless enabled, they are typically not captured in the log file.

When a juror asks to whisper with the jury scientist, this appears on the Electronic One-way Mirror field of the jury scientist. The scientist then uses the “Answer Juror” command, 565, to respond to the last whisper requested to the scientist. This uses a special screen so that the computer can keep track of which juror has asked the particular question. An alternative command, which would give the same result would be to use the “Whisper with the Jurors”, command 560, and select the appropriate juror.

Command 575, “Review Juror Info” allows the lawyers and researchers to review the information given by the particular juror when they answered the questionnaires as they logged into the Jury Room. More detailed background information may also be available from the jury scientists' data base. For example, when a scientist is whispering with a particular juror, the jury scientist may enable the “Review Juror Info” function to gather more information on the particular juror with whom the jury scientist is whispering. This allows the jury scientist to direct more pointed questions to the particular juror based on that juror's profile. The “Poll Jurors” command, 580, is available only to the jury scientists. When the jury scientist enables this command, it sends a message and a sound or “beep” to the jurors. A message will appear in the jurors' “voting response box”, to be discussed below, and in the Electronic One-way Mirror, 540, on the Observation Room screen. The scientist is allowed to select the number of seconds for the message to display before the “voting response box” returns to its normal function.

The “direct votes” command button, 585, is available only to the jury scientists. It displays the “vote control screen.” This allows the jury scientist to select among pre-written questions or to draft a new question for the jurors to consider. Once enabled, the questions are then displayed in the question display box, 520. Additionally, on the same screen, check boxes and radio buttons will be provided to allow the jury scientist the option of determining if the vote tally is to be displayed to the jurors or not, and if the jurors are required to respond before continuing with the deliberation process, or to allow the juror's response to be optional.

FIG. 6 illustrates an example of the Jury Room screen that is presented to jurors who are logged in and participating in a virtual mock trial. In FIG. 6, the title of the screen which the jurors are viewing is displayed at 610.

When a jury scientist enables command 585 in FIG. 5and “directs votes” the question presented to the jurors is displayed in the jurors' “question display box” at 620. This question is typically called a “vote” since the options available to the jurors at 635 are “vote′yes′” or “vote′no′”. If the options available to the jurors were “strongly agree,” “agree,” “neutral,” “disagree,” and “strongly disagree” then the question would typically be called a “poll.” Depending on the visual interface supported by that particular virtual mock trial, other response options such as a text-answer-box and a numeric-answer-box, or a slider might be used in the poling. These substitute responses would take the place of the “vote′yes′” or “vote′no′” radio buttons. 630 normally presented in the virtual jury room, allowing the jurors to know how well they are moving towards a consensus about the question. However, there are times when the jury researcher will keep block 630 from the jurors, e.g., when the system is being used as a gallery jury or if the researcher wishes to independently test the jurors reactions.

In some polls of the jurors, the jurors are asked not only to give the direction of their attitudes (agree-disagree) but also the intensity of their beliefs. This is typically done by including an additional question where jurors respond that they are “very sure,” “sure,” “not sure,” or “confused” about the answer they are making to the poll, or similar responses descriptive of the intensity of their beliefs.

Another variation of the jurors' response to photographs, streaming videos, and exhibits requires a specifically modified personal computer for each juror. These have data input boards designed for biofeedback and monitoring human physiological responses installed along with the usual equipment necessary for network visual and auditory display. The finger-tip-temperature, galvanic-skin-response, and heart-rate parameters are measured and summarized during the time the each juror is exposed to the exhibit. When the juror makes his or her rating and leaves the exhibit, the juror's computer up-loads the physiological information to the host. Analysis of this data in step 150 of FIG. 1 permits the emotionality of exhibits to be empirically estimated. The biofeedback measurement and data input computer boards are existing technology used by the Virtual Trial system to make these physiological measurements.

The tabulated polls of the jurors are also used in analysis, FIG. 1 at step 150. The analysis step includes the computation of a probability model of the results of the Virtual Trial, the Verdict Forecast. This analysis follows the several votes of the jurors to determine the most likely outcome. The probabilities are determined from the jurors' votes (so a 10 out of 12 vote becomes a 0.83 probability or 83%). The Virtual Trial system uses 70% as the default definition of “reaching consensus;” however, the jury researchers using the system may modify this. The probabilities developed from the several votes are also used to adjust the dollar value of any damage award made. The uncertainty of the verdict reduced the present value of the damages found by the jurors. The underlying technology applied to these predictions and estimates is that of theoretical statistics generally and probability modeling.

The virtual mock trial system includes the function of preparing questions and response options before the time of the actual deliberations. This allows the researcher to quickly change and display questions for voting and polling. However, a question design function is also available during the deliberations to allow for flexible deliberations.

The “voting response box” at 630 shows the tabulated results of the votes that the jurors have made on the current question in the question box, 620. The jury scientist has the option of restricting this from the juror's view. If the jury scientist does choose this option, then his count is updated periodically during the deliberations.

This same text box can also be used by the researcher to stimulate the jurors. The researcher can type messages that are displayed for several seconds in box 630 before box 630 returns to showing the current results. For example, the researcher might stimulate the jurors with “We will need to move on, so please make your final votes on this question. Thanks.” The window will make a “beep” when a stimulating message is initially displayed to direct the juror's attention away from the other fields on the Jury Room screen. The researchers can hide the voting response box 630 results from the jurors by disabling the box 630 in the Jury Room when the researcher does not want to influence the deliberations with the results of the current vote or poll.

The jury deliberation box 640, is a scrolling text box that displays the jurors' deliberations. This appears as the Electronic One-way Mirror 540 in the Observation Room. In the Observation Room, text box 540 may show the jurors' deliberations, whispers, questions, and individual votes, and also shows what each researcher is saying to the jurors, and what other lawyers are saying to each other. However, in the Jury Room, box 640 is limited to the jurors' deliberations. Thus, box 540 is the Electronic One-way Mirror of box 640.

This function of the virtual mock trial system is called the Electronic One-way Mirror because it provides the researchers' insights into the jurors' deliberations as does the physical one-way mirror. However, as can be seen, the invention provides for greater flexibility than the physical one provides. The deliberation screen is scrolling text on the Jury Room which shows only part of the information which is available to the observers, such as the deliberation of other jurors. However, the Observation Room box 540 shows whisper messages from jurors to each other and to the researchers. When the visual display interface supporting the virtual mock trial system is enabled, this text box will have a scrolling slider on the right side of the screen to allow the observers to look back at the text that has already scrolled off of the screen. This scrolling function will be enabled in the Jury Room at the choice of the researcher.

The contents of the Electronic One-way Mirror are captured in a storage file, real time. This text file provides the basis for later analysis and reporting of the results of the deliberations. Additionally, in this way, it is also the log of the deliberations.

When jury deliberations are occurring, the jurors will type their comments into their text-input box at 670. When the juror is ready to transmit his comment to the other jurors, they push the “Say to Other Jurors” button 645 to publish it into the Electronic One-way Mirror and deliberation screen. Prior to publishing it to the other jurors, the juror may edit his comments. When a juror desires to whisper with another juror, then the “whisper with another juror” button 650 is pressed by the juror to enable a whisper function with that juror. When button 650 is pushed, a listing of the jurors in the Jury Room will appear on the enable's deliberation screen. The juror desiring a whisper session will then pick the appropriate juror to whisper and enable a whisper session with that juror.

If a juror desires to whisper with the jury scientist acting as the Bailiff, the juror will enable button 660 to whisper with the Bailiff.

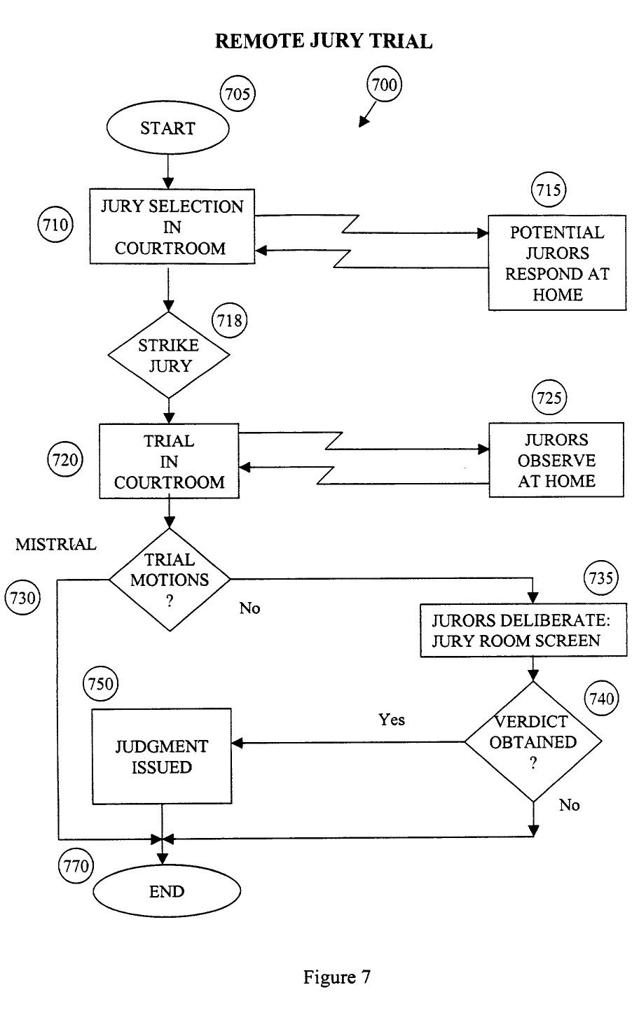

Refer now to FIG. 7 in which is illustrated a flow chart describing the methodology to conduct a remote jury trial under the present invention. FIG. 7 describes another embodiment of the present invention. In this embodiment, the present invention allows for, a remote jury trial to be conducted. Using the present invention for this embodiment, clients will agree that a remote jury may be utilized to operate as the triers of fact for their case. The advantage of utilizing the present invention to conduct a trial using a remote jury is that it removes the requirement of maintaining a large pool of jury on site during the jury selection process and during lengthy motion trials. Additionally, jurors' time is more efficiently utilized because a trial may be conducted during the day and the jurors may log onto the trial at night. This voids the jurors having to sit through lengthy motions arguments by counsel and various motions during the trial.

Referring now to FIG. 7, once the clients and the Court agree to utilize a remote jury for the trial, the process starts at 705. Prior to 705, potential members of the jury have filled out various questionnaires electronically. This is similar to the procedure as described for the virtual mock jury. The questionnaires are compiled into a data base allowing counsel to select the appropriate jurors for the case via an enlarged jury pool. Jury selection can either occur in the courtroom as in step 710. However, as an alternative, counsel may develop with the help of an independent third party, a separate more descriptive jury questionnaire for the jurors to answer at home and submit at a later time. Then counsel can review the jurors' responses and select the jury on that basis. Depending on the construct of the remote jury trial, the jurors may be logged on during the jury selection process, or counsel may agree to permit the jurors to respond to the questionnaires at a later time, for example later at night when the jurors return from work, and reply by a certain deadline as indicated in Step 715.

Once a suitable number of potential jurors have responded to the questionnaires at 718, counsel will strike the appropriate number of jurors needed to select a jury for the remote trial in Step 718. Once the remote jury is selected, the Court or an independent third party will notify the jurors of the appropriate date, time and URL location for the jurors to connect in order to view the trial. Depending, again, on counsel's agreement, the jurors may be asked to view the trial materials on a daily basis at their leisure or to view the trial real time from their homes. As described above in the preferred embodiment, counsel's argument, trial exhibits, deposition exhibits, and witness examinations and cross-examinations may be viewed by the jury either by video or audio streaming or by a transcribed version of the day's events.

It is important to note that in this embodiment, it is not required for the trial to occur in a real courtroom. In fact, the parties and the court may each be linked into a virtual courtroom, with each party located at a separate and distinct location. For example, the parties and court may access the URL where the trial will be conducted.

Once the jury is selected, the trial in the courtroom begins in step 720. As mentioned above, the jurors observe the events in the courtroom either real time or later during the day as shown in step 725. At the conclusion of the trial, trial motions are put forth before the court in typical fashion in step 728. The advantage of using the remote jury trial is that the presence of the jurors is not needed, and therefore their time is not wasted. Once the trial motions are concluded, the judge rules on the trial motions, including a motion for mistrial, which typically follows every trial. If a mistrial is granted in step 730, the trial ends in step 770. However, if no mistrial is declared, then the jurors are “sent” to the jury room to deliberate in step 740. The jury deliberation occurs in the jury room as described above. However, in a remote jury trial, there will be no researcher or lawyers observing the jury deliberations. Thus, the jury room is set up to mimic the actual function of a physical jury room located in a courthouse whereby the jurors may deliberate amongst themselves free from outside interference. However, the important distinction and utilization of this invention is that the jurors are not required to be in a central location, and therefore time, cost and expense are saved. As described above, the jurors have access to the trial exhibits, the witness depositions, the cross-examinations and directs, and the various trial exhibits that were admitted into evidence as appropriate. The Court will make the rulings necessary to determine to which exhibits the jurors have access to and to which they do not. Therefore, if a juror wishes to review an exhibit or cross-examination, for example, the juror is able to “call up” the appropriate exhibit to view during the deliberations. If intended by the parties, the remote jury trial can be set up so that as each juror reviews various trial exhibits, the various lawyers and the Court will be informed so that they can track the jurors' progress.

Once the jurors reach a verdict in step 760, that verdict is transmitted to the judge of the case. The judge then issues a judgment in step 750 concluding the trial in step 770. If no verdict is obtained, then the judge will issue a mistrial and the trial will end in step 770.

As described above, another variation to the remote jury trial theme is a trial that is completely conducted via the Internet. An example of such an embodiment follows.

A virtual trial can be conducted by agreement of both parties via the Internet. In such a virtual trial, the parties agree to allow an independent third party to operate as the trial facilitator. The facilitator functions separately from the judge. The facilitator's job would be to ensure that the trial exhibits are prepared and operate, and to ensure the smooth progression of the virtual trial technology. The parties may agree to an independent third party acting as a trial judge making rulings and admitting various evidence. Because the trial would occur over the Internet, no particular forms rules would be applicable. Therefore, the parties would also agree to the procedural rules necessary to conduct a trial. Such a trial may be conducted via contractual arrangements by the various parties such as currently done in mediation or arbitration.

In such a virtual trial, the jury selection and jury operation would occur as described in the remote jury trial for FIG. 7. The difference being that the parties would conduct their examination, cross-examination, presentation of trial exhibits and witnesses via the Internet, rather than from a central location. This would allow the parties to operate from distant sites and would reduce the cost of the trial. Again, as described above, the trial exhibits and witnesses can be presented real time via video or audio streaming or can be presented to the jurors at a later time. For example, if a party decides to present a key witness during the trial, both teams of counsel would be logged on to the proper URL site for the conduct of the trial. During the presentation of the direct examination, the witness could either be examined via video streaming, or the examination may occur by counsel typing in the questions with the witness responding via typing in his response. Opposing counsel can view the direct examination and object as would occur during a normal trial by hitting an “object” button. Once the object button is enabled, the judge would then rule on the various objections with the various objections occurring on a whisper screen. This prevents the jury from viewing counsel's arguments during the objection and permits the trial to occur in a rapid fashion. Once again, it is not necessary for the jurors who are participating in the virtual trial to view the trial real time. This allows the jurors to participate during the time that they actually have available during that day. The only requirement necessary would be that the jurors deliberate in the jury room at the same time.

It is important to note that FIG. 7 can be utilized to provide a virtual arbitration proceedings. In this embodiment, the arbitrators will be substituted for the virtual jurors, and for the virtual judge. Using this methodology, virtual arbitrators may be located in a different physical from the parties, yet still act as the arbitrators. The present invention allows for more than one arbitrator to be involved in the process. In this embodiment, the Jury Room will be re-labeled as the Arbitrators Room and the arbitrators, if more than one is involved will deliberate as necessary in the Room outside of the view of the parties.

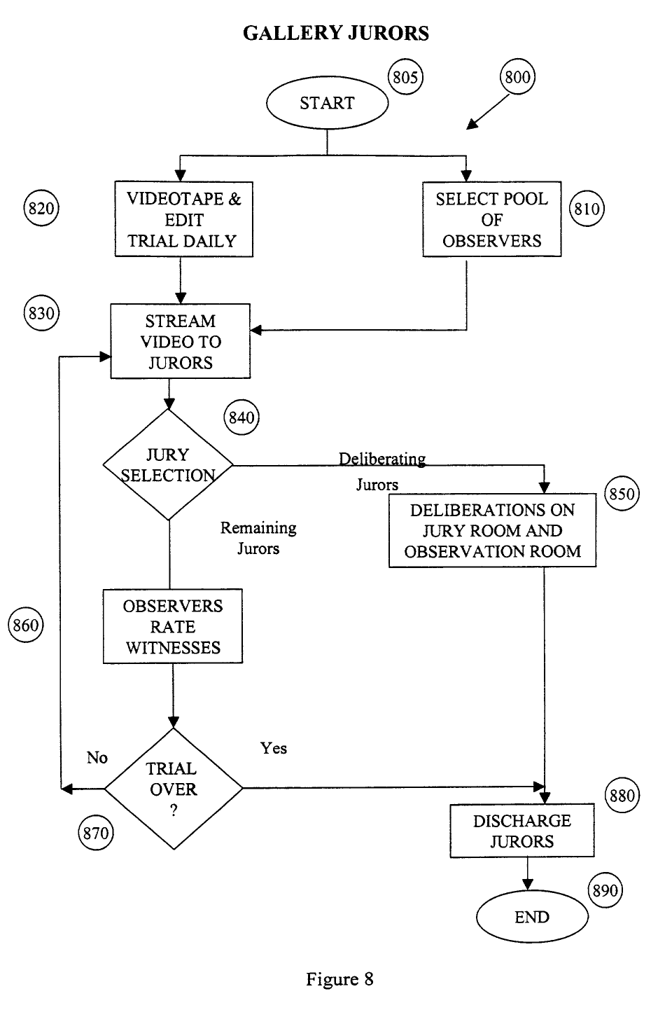

A further embodiment of the present invention is shown in FIG. 8, which shows in flow chart form the present invention when utilized to incorporate a virtual gallery jurors or shadow jurors. A “gallery jury” is a jury research procedure whereby people are selected be present at the courthouse and attend the trial of a lawsuit as observers. At the end of each day, they are typically debriefed on the trial's actions. The result of these debriefings are used to guide the trial team in conducting the rest of the trial. Additionally, the present invention can be used to mirror the process of jury selection to allow counsel to improve upon the jury selection process, and to provide for an accurate representation of the opinion maker.

FIG. 8 shows the use of the present invention to support a virtual gallery jury process. The virtual gallery jury process may occur utilizing a time delay between the trial events and when the observers watch a video tape recording of the trial actions. If the trial is streamed on closed circuit television or video streamed over an electronic communication network, for example, the World Wide Web, the gallery jury process can occur real time.

Once a client decides to utilize the virtual gallery jurors, the process starts in step 805. Observers are selected to match the jury that was seated in the actual trial through the voir dire process in Step 810. Preselection of a pool of potential observers must occur to have the observers ready to go at the start of the trial. The present invention facilitates this because, as described above, typically a data base of potential jurors is kept in a centralized data base location utilizing the answers of potential jurors from across the country. In this manner, the jury scientist may rapidly process the characteristics of the actual juror and match them to the data base characteristics of potential observers and formulate a significant pool of virtual gallery jurors.

One problem with gallery observers in the traditional in-courtroom technique is that upon having the jurors deliberate the issues of the lawsuit at the end of each day, they subsequently reach conclusions which are throughout the remaining portion of the trial intended to defend their previous conclusions. Hence, traditionally, subsequent to deliberating the jurors begin to listen to the witnesses with a bias caused by their formulated opinions. The methodology utilized to reduce this bias is to provide only some of the observers to deliberate each evening. Once having deliberated, these observers are discharged as having finished their work. Therefore, to be able to accommodate the client and have a gallery jury throughout the trial, a significant number of pool of observers are needed to observe the trial throughout the process. However, this need for a large pool of jurors clashes with the physical constraints of most courtrooms. Therefore, if the pool is too large, the pool will not be able to sit and observe the trial throughout the trial process. The advantage of the present invention is that the virtual gallery jury permits a larger number of observers than can fit into a courtroom to observe the jury process and to participate in the discussions as needed.

Once the client hires the jury scientist to conduct a virtual gallery jury, the jury scientist will video tape and edit the trial daily in step 820. By using real time editing, the parts of the trial not observed by the sitting trial jurors are not presented for the virtual gallery observers to observe. As those familiar in the art will recognize a lot of what trial jurors actually do is wait. By presenting the trial in a video tape edited format, as much as a 50% reduction in the time necessary for observing trial actions on the video tape is needed as compared to the actual sitting time in the courtroom.

Additionally, at the start of each gallery jury trial, the jury scientist will select the virtual gallery jury pool based on the actual jury sitting in the trial. As mentioned above, the selected pool will be notified, typically by e-mail, as to the time, date and URL location in order to participate in the gallery jury. This occurs in step 810. As mentioned above, the virtual gallery jury may view the trial process in two different methods. The first method is streaming the video to the virtual gallery jury in real time. After editing, the streaming video alternative has the video feed from the trial sent out to the observers in Step 830. When the trial jurors are removed from the courtroom, the feed is replaced by a screen that asks the virtual gallery jury for their rating of the witnesses on the stand or the arguments underway. This screen may also ask the observers what unanswered questions they may have about the witness testifying or the argument underway. The virtual gallery jurors' responses will be compiled into information which is condensed by the jury researcher and communicated to the trial team in the courtroom.

When the real time streaming video approach is used, the virtual observers will make ratings on the witnesses as the testimony is presented in Step 860. The screen from which the observers view the trial proceedings will be set up by the researches prior to the trial such that it has the appropriate responses for the virtual observers to make. From time to time, the jury researcher will direct the gallery observers and summarize their ratings. These summaries can be flashed to the counsel table using the whisper screens of the present invention and perhaps a cellular telephone digital modem connected to a lap top computer on the counsel table. In this way, the questioning of the witness on the stand can respond to the input instantaneously from the virtual gallery observers.

From time to time, some virtual observers will be selected to hold deliberations based on what they have observed of the trial up to this point in step 840. As mentioned above, the process of deliberation “spoils” the virtual observers from serving as unbiased observers from that point on. Once the particular jurors are selected to deliberate, they proceed in step 850 to a virtual Jury Room which is connected to an Observation Room as described above. The trial researcher will conduct the deliberations as necessary to provide the clients with the necessary information. The results of the deliberations are summarized and passed to the trial team during the evening after the trial rises for the day. This information is utilized to guide the trial counsel's strategy and to make decisions about the conduct of the trial. The jurors who are not chosen in step 840 to be part of the deliberating jury team will remain as jurors and observe and rate the witnesses in step 860. The virtual observers rank the witnesses that appeared in that day's action. The virtual observers are asked to write any unanswered questions that they may have about the trial and the witness as it has proceeded to that point. The results of the rating and the information obtained from the observers' questions are summarized by the jury research and presented to the trial team who use it to guide the conduct of the trial.

This process occurs until, in step 870, the trial is over. Some trials end in mistrials. In other trials, the decision may be made that the gallery observers are no longer desired. When this occurs, any remaining observers deliberate, as above, using the Jury Room and the Observation Room screens and are then discharged in step 880.

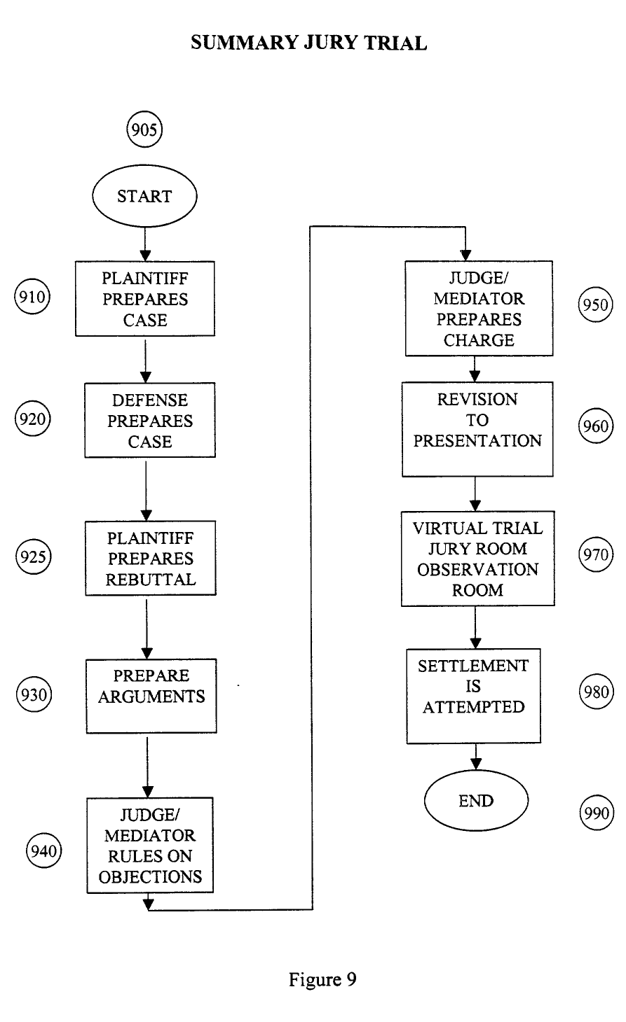

Refer now to FIG. 9 entitled “Summary Jury Trial” in which is shown a flow chart methodology for a virtual summary jury trial to occur using the present invention. The virtual summary jury trial is an alternative dispute resolution technique. Use of the virtual jury trial system allows it to proceed in a smooth and cost effective manner. This type of trial may be ordered by a court or agreed upon by the parties in order to more effectively negotiate a settlement to a dispute. Once it is decided that a virtual summary jury trial is to occur, the clients contact an independent third party to start the process in step 905.

The initial step, after the parties have agreed to participate in the virtual summary jury trial, is for the plaintiffs to prepare their case presentation. This preparation follows the basic logic in flow chart 2, “Ready Case Presentation.” The main difference here is that after the plaintiffs have prepared their case in Step 910, they pass it electronically on to the defense. The defense then prepares their case in step 920. Once the defense case is fully prepared, it is passed back to the plaintiffs so that they may prepare the rebuttal case in step 925.

Both parties then prepare their arguments in step 930. The parties' prayers to the jury for relief are included in the arguments. For example, the plaintiffs and defense might both include tables for the jurors showing the damages they requested the jurors to find, for example, in a negligence case. Once the arguments in the case are prepared, the judge rules on any objections set forth by either party. It is only after the parties have finished the initial preparation of their cases, the rebuttal and their arguments that these are transmitted to the judge for review. Then the parties make objections to either the content of the presentation or to the characterization of summary evidence. Negotiation and direction by the Judge resolves these objections.

After the objections are resolved by the Judge in Step 940, the parties and the Judge decide on the jury charge and questions to be put forth in the jury verdict form. This is prepared in step 950. These will be the screens that the jurors view in the jury room during deliberations. Finally, prior to handing the case to the jurors, and in response to the outcome of the objections, the parties revise the presentation and the arguments in accordance with the Judge's orders. This occurs in step 960. The case is then presented to the jurors in one event in the same way that jury-research focus groups are conducted as described in FIG. 1. The Jury Room and Observation Room screens are used. The jurors are selected with consultation of the Judge. During the virtual summary jury process, the parties and the Judge may use the observation room to follow the deliberations. A juror researcher plays the role of the bailiff in managing the deliberations on the Observation Room screen following the direction of the Judge. During the deliberations or after, the Judge and the parties attempt to reach a settlement of the case.

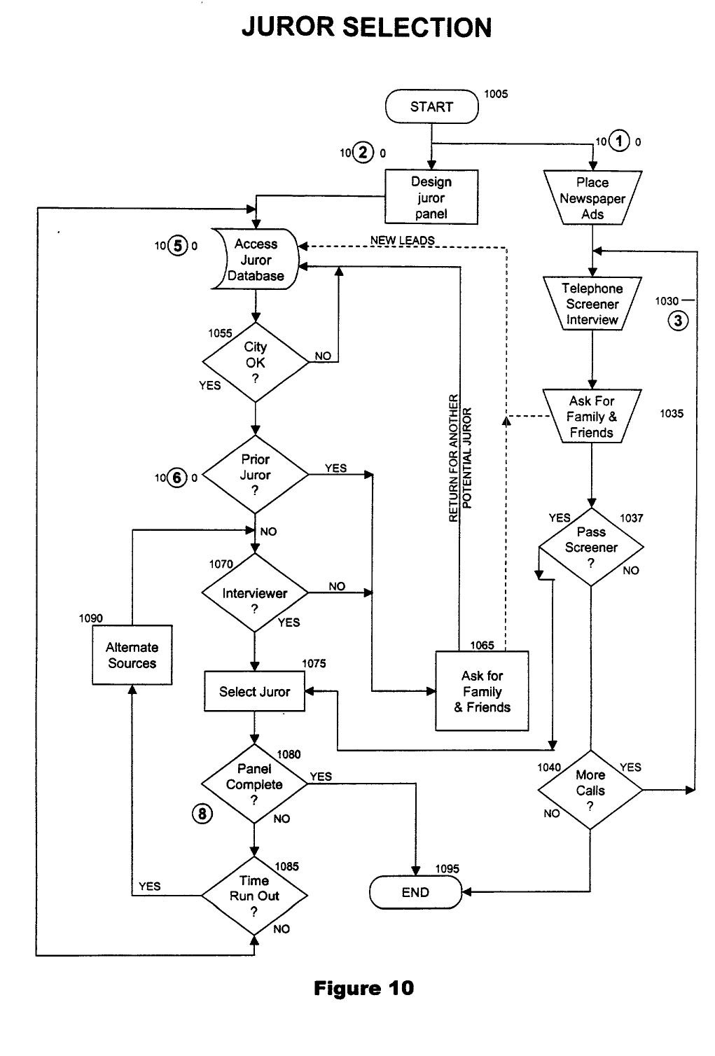

Refer now to FIG. 10 in which is presented a methodology in flow chart form that described how virtual jurors are selected using the present invention. In step 1005, the trial researcher decides that a jury pool is needed to conduct one of the different embodiments described above. For the purpose, of this discussion it will be assumed that a virtual mock trial is to be conducted, however, those skilled in the art will recognize that the methodology herein described will work with other embodiments.

After the decision to conduct a virtual mock trial is made, the trial researcher will design a prospective jury panel in step 1020. Here the research will analyze the behavioral requirements necessary to fill a jury panel.

In the past, jury research--and focus groups generally--have small numbers of subjects. From a research point of view this means it is more important to have a sample that is representative of the population being studied than having a random sample.

The population studied in juror research is the population of potential jurors. While exact procedures differ from district to district, generally potential jurors must be over 18 years of age and be registered voters. They must have no felony convictions (or plea bargains at the felony level).

Additionally, in different districts there are micro-cultural differences as to who responds to jury summons. For example, some districts within a state have only a tiny percentage of a summoned ethnic group responding, in other districts they show the same percentage as the general population. This means that the research jurors need to reflect the demographic appearance of the typical jury in the district, rather than the demographic appearance of the surrounding communities. Another constraint is the need to not have only a single member of any easily identifiable ethnic or cultural subgroup. If there is only one member of an ethnic group, that person may not speak up with the typical view point representative of that ethnic group on a topic. When they are two members of the same ethnic group in the dynamic, they are more comfortable in telling about the typical minority viewpoint.

Some of the important variables that researchers must consider are education level, occupation, ethnic group membership, religious group membership, marital status, parental status, age, gender, and region of birth and childhood. However, not all of these will be important in every case.

The design of the juror panel also includes providing for sufficient number of people who agree to be research jurors to have an adequate study. Different districts have different no-show rates; however, the typical no-show rate expected is about 30%.

In the past, these considerations affected the ability of the researcher to provide an adequate number of panelists to participate in the mock trial session because of the limited pool of people available within the chosen forum. However, the present invention enlarges the available pool of applicants that the researcher can choose. This is because the present invention allows applicants to complete a general questionnaire for screening purposes and maintain the applicants answers in a computer database for access at a later time. When the research decides on the necessary make-up of the virtual jury panel in step 1020, the research can then implement a “filter” to screen out all but the applicants with the necessary characteristics. Once the filter is created, the researcher will then access the database in step 1050 and apply the filter to select an adequate number of panelist to contact for the virtual mock trial. Examples of the filter might be to select the panelists based on the applicants location in step 1055, or deny an applicant if he has been a prior juror in step 1060.

If, after the filter is applied, an inadequate number of panelists have not been selected, the research may choose to contact various “unsatisfactory” applicants for suggestions as to other family members or leads to other applicants who might be willing to participate in step 1065. Once these new leads are contacted, they will electronically fill out a questionnaire, and the appropriate filter will be applied to the new questionnaires.

Once a correct number of applicants have been approved for the particular virtual mock trial, the researcher may desire to conduct a specific “screening” interview any one of the potential panelist or all in step 1070. In the past, this screening interview might be an in person interview or a telephone interview. However, the present invention allows for the interview to be conducted on line. For example, the researcher might contact the potential panelists and request that they log into a Virtual Jury Room at a particular time and URL location as described in FIG. 6. When the panelist log in, the researcher might conduct the interviews in Whisper mode or open for all panelist to view. Additionally, the research might choose to have the panelist complete an additional questionnaire for the interview process. In either case, as described above in FIG. 6, the advantage of the present invention is that the interview is stored in a storage medium such that it can easily be accessed at a later time if required.

There are several pieces of information about potential participants that are gathered during the screening interview. The interviewer is often called the “screener.” The screener must establish that the potential jurors are qualified to sit as jurors in this district. In the past, this qualification was directly tied into the physical location of the applicant, as well as other factors. However, in the present invention, the research might decide to accept applicants who would normally be qualified to sit on the jury if they lived in the desired form. Again, as described above, this aspect of the invention allows for a greater pool of applicants to choose from.

Part of the screener duty may be to determine if the potential jurors knows or has connections with any of the parties. The screener may also rule out those who are currently in any lawsuit and those who have been a party in a similar lawsuit to the case under study. People who work for lawyers may be ruled out, as are news reporters. Obviously the potential juror must be willing to participate and have the time and day of the study open.

If the potential panelist's interview is satisfactory in step 1070, then the applicant is selected as a juror in step 1075. At this point the researcher can provide the panelist with the appropriate time, URL, and password for the virtual mock trial in step 1075. If the panel is complete in step 1080, then the panel selection process ends in step 1095. If the panel is not complete, then if time for selecting a panel has not run out, then the research will attempt to complete the panel by either returning to step 1050 or 1070 whichever is appropriate. If time has run out, then the research must decide on whether to extend the time for search for a panel or cancel or begin the virtual mock trial with a condensed virtual jury in step 1095. If time has run out and the panel is not complete, then the researcher may decide to reevaluate the “filter” used to screen out the prior applicants and adjust the filter to maintain as low an error as possible, while increasing the panelist pool in step 1090.

Part of the jury selection process in the present invention provides for having a database of applicants that the researcher can access. To provide the database, the research can advertise the need for applicants in a variety of methods in step 1010. The preferred method is to advertise using e-mailing, and web based advertising methods. Traditional methodologies my be used as well. For example, the researcher may decide to place a newspaper ad requesting applicants. When web base advertising is used, then the applicant can log onto the appropriate web site to complete the questionnaire for storage in the database. However, if traditional advertising is used, then the applicant might be asked to either reply by accessing a web site or calling a listed telephone number. If a responded contacts the researcher through the telephone number, then the present invention allows for an interview to be conducted over the telephone with the interviewer completing the requisite form for database storage in step 1030. During this interview, the applicant may be asked if he has access to the Internet. If the applicant does not, then the interviewer might ask if the applicant is able to travel to a prearranged location where access to the Internet is available. In this manner, the applicants across the country may still be considered for a panel even if they do not have immediate access to the Internet.

Upon completion of the telephone interview, the applicant will be asked for further references that the research may contact via e-mail or telephone in step 1035. This process of building a database of applicants can be an ongoing process that the research continues in order to have ready access to an adequate number of applicants for selection of panelist. In this manner, the research is able to rapidly provide a panel of jurors in a cost effective manner.

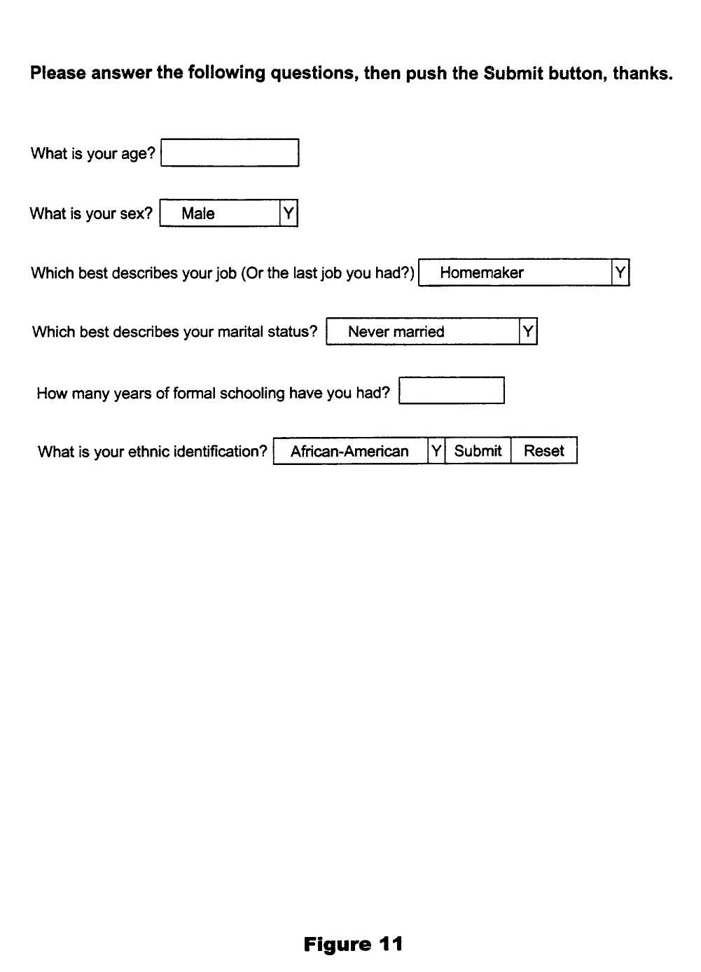

Refer now to FIG. 11 which is shown an example of a general questionnaire that is used to by the jury scientists. Jury questionnaires are used throughout the jury science process. The present invention provides for all questionnaires to be completed on various screens. This allows the completed questionnaires to be immediately placed in a computer storage file in a database format, allow the jury scientist to access the results of the questionnaires for analysis. FIG. 11 shows a typical screen which shows a variety of questions 1110. When the applicant has completed the questionnaire, the applicant has the choice to submit the answers to the central database for storage by pressing the “SUBMIT button 1130 or cancel his responses by pressing the “CANCEL” button, 1120. If the applicant cancels his responses, he may reenter new responses to be submitted after completion.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It is therefore, contemplated that the claims will cover any such modifications or embodiments that fall within the true scope of the invention.

What is claimed is:

1. A method of conducting a mock trial via a computer network comprising the steps of:
developing case information for presentation to a selected group of virtual triers of fact;
storing the case information in a computer database;
setting up a virtual jury room for establishing communications between the virtual triers of fact;
setting up a virtual observation room supporting observations of selected communications in the virtual jury room between the virtual triers of fact;
selecting the group of virtual triers of fact;
selectively presenting the case information in the computer database to each of the virtual triers of fact via the computer network;
establishing communications between the group of triers of fact using the virtual jury room; and
observing selected communications between the triers of fact in the virtual observation room.
